(19) United States
(12) Patent Application Publication
(10) Pub. No.: US 2005/0254599 A1
(43) Pub. Date: Nov. 17, 2005

(54) Device and method for down-mixing of a radio-frequency signal, which has been received by radio, to baseband

(76) Inventors: Xiaofeng Wu, Neubiberg (DE); Martin Kruger, Munchen (DE); Holger Neuhaus, Munchen (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/118,856

(22) Filed: Apr. 29, 2005

(30) Foreign Application Priority Data
May 4, 2004 (DE) 10 2004 021 859.5

(51) Int. Cl. H04L 27/06

(52) U.S. Cl. 375/316

(57) ABSTRACT

A receiver device includes a first mixer for production of a first analogue intermediate signal by down-mixing of a radio-frequency signal. The device also includes an A/D converter for production of a first digital intermediate signal, a second mixer for production of a second digital intermediate signal from the first digital intermediate signal, and a third mixer for production of a digital baseband signal from the second digital intermediate signal. The second mixer has a higher sampling frequency than the third mixer.

### REFERENCE TO RELATED APPLICATIONS

This application claims the benefit of the priority date of German application DE 10 2004 021 859.5, filed on May 4, 2004, the contents of which are herein incorporated by reference in their entirety.

### FIELD OF THE INVENTION

The invention relates to a device and a method for down-mixing of a radio-frequency signal, which has been received by radio, to baseband. The device is integrated in a radio receiver.

### BACKGROUND OF THE INVENTION

Mobile radio receivers for time-division multiplexing systems, such as GSM/EDGE or IS-136, have to process comparatively narrowband signals, on which large interference signals at adjacent frequencies are superimposed, with as little noise as possible and with as little other interference as possible.

At a radio receiver the radio-frequency signal at the antenna input is converted to a digital sampled signal in baseband. This part of the mobile radio receiver comprises, inter alia, mixers for frequency conversion, two analogue/digital converters for sampling of the quadrature components of the analogue signal, and digital circuits for further processing of the digital signal. The signal that has been processed in this way is then supplied to an equalizer.

In recent years, homodyne receivers have become ever more important for frequency conversion. The lack of the intermediate frequency stage which characterizes heterodyne receivers makes it possible to achieve greater chip integration, and thus a cost reduction. Pure CMOS technology is being used ever more frequently instead of BiCMOS technology, likewise for cost reduction reasons.

Homodyne receivers have the disadvantage of the interference, as enumerated in the following text, in the signal to be sampled by the analogue/digital converter. The CMOS technology results in 1/f noise being added to the signal. Couplings in the mixer and second-order non-linearities lead to a large DC voltage interference signal (DC offset). Second-order non-linearities also lead to the envelope of the interference signals in adjacent channels being coupled to baseband. In non-synchronous networks, this leads to interference in the form of a ramp in baseband. The GSM Standard provides a specific test for the sensitivity of the receiver to interference such as this. This so-called “AM suppression test” is described in “GSM recommendations 05.05 Version 8.5.0”, ETSI, July 2000.

If the radio signal is mixed directly to baseband, where it is sampled, the interference signal occurs around 0 Hz, and thus in the centre of the wanted signal. Down-mixing of the radio signal in this way without any intermediate stage is referred to in the specialist literature as “zero IF (intermediate frequency) sampling”. As an alternative to this, in so-called “low IF sampling”, the signal is first of all down-mixed to a low intermediate frequency and is sampled before being mixed to baseband. In this case, the interference sources occur at the negative intermediate frequency. Depending on the choice of the “low IF” frequency, the interference sources which are close to DC are in consequence either no longer in the wanted spectrum at all, or are only at the edge of the wanted spectrum.

The major disadvantage of a “low IF” architecture is the creation of mirror-image spectra, which result from gain errors and phase errors in the quadrature components. In the case of an excessively high intermediate frequency, for example above 110 kHz, spectra from interference sources which are not directly adjacent and whose levels in accordance with the GSM Standard may be more than 41 dB above the wanted signal, may be reflected into the wanted spectrum. An intermediate frequency of about 100 kHz is generally chosen as a compromise. In this case, the intermediate frequency is generally not defined from the start, but is designed such that it can be adjusted in 1 or 2 kHz steps.

An intermediate frequency, as has been described above frequently, however, does not have a simple ratio to the symbol rate which, in the GSM Standard, is 13 MHz/48. Since the sampling rate is a multiple of the symbol rate, the intermediate frequency therefore does not have a simple ratio to the sampling rate, either. The digital conversion to baseband is thus generally complex. Furthermore, the CMOS technology by means of which the RF chip is produced is not suitable for complex digital circuits. For this reason, the sampling and the digital processing must be carried out on the baseband chip. However, this is disadvantageous since the digital processing is highly dependent on the RF architecture, and the baseband chip must therefore provide variants for all feasible RF architectures.

In conventional modern mobile radio receivers, the radio-frequency signal which has been received is mixed directly to baseband, using the “zero IF” procedure, where it is sampled. FIG. 1 shows a block diagram of typical signal processing in baseband in a mobile radio receiver. An analogue baseband signal which is produced by an RF mixer (which is not illustrated in FIG. 1) is passed to a hardware circuit 1, where it is converted by means of an analogue/digital converter 2 to a digital baseband signal. This is frequently achieved using an analogue/digital converter with a high sampling frequency of, for example, 13 MHz or 26 MHz. In comparison to the symbol rate in the GSM standard, this corresponds to oversampling with a factor of 48 or 96, respectively.

The sample values of the oversampled baseband signal are decimated by means of a multirate decimation filter chain 3. The baseband signal then passes through a low-pass filter 4.

The rest of the processing of the baseband signal, such as DC compensation, channel estimation, channel equalization and channel decoding, is carried out in a digital signal processor 5.

The implementation shown in FIG. 1 allows minimal complexity for the provision of the digital circuit. However, this circuit is not robust with respect to interference such as 1/f noise, DC offset and second-order non-linearities.

FIG. 2 shows the block diagram of a circuit arrangement for baseband reception in the form of a “low IF” architecture, as has been proposed in “A GSM/GPRS Mixed-Signal Baseband IC”, D. Redmond, ISSCC 2002.

An analogue intermediate frequency signal, which has been converted to a “low IF” frequency by an RF mixer (which is not illustrated in FIG. 2), is first of all passed to an analogue/digital converter 6, which converts it to a digital intermediate frequency signal.

The digital intermediate frequency signal, which has been sampled with a high oversampling factor, is decimated to an oversampling factor of 2 in a multirate decimation filter chain 7. The multirate decimation filter chain 7 has series-connected low-pass filters 8 and 9 and a high-pass filter 10 for this purpose. The low-pass filters 8 and 9 are 6th-order and 51st-order low-pass filters respectively, and, in addition, reduce the sample values of their digital input signals by a factor of 12 or 4, respectively. The high-pass filter 10 is a 31st-order high-pass filter.

The intermediate frequency signal which is emitted from the multirate decimation filter chain 7 is passed to a digital mixer 11, which converts the intermediate frequency signal, which is still at the “low IF” frequency, to baseband. A low-pass filter 12 which is connected downstream from the mixer 11 and is a 15th-order low-pass filter filters the spectra of the directly adjacent channel interference signals out of the baseband signal. The rest of the processing of the baseband signal is carried out in a digital signal processor 13.

Since, in the case of the “low IF” architecture described above, the digital intermediate frequency signal is fed into the multirate decimation filter chain 7 with a high oversampling factor, and an oversampling factor of 2 is not achieved until the output of the multirate decimation filter chain 7, steep-edged, linear-phase and thus complex filters are therefore required for the multirate decimation filter chain 7 for high sampling rates, in order to avoid aliasing effects.

A further possible way to convert a radio-frequency signal, which has been received by radio, to a baseband signal is to down-mix the intermediate frequency signal, which has been converted to a “low IF” frequency, to baseband with a high sampling rate. Although this reduces the implementation complexity of the filter, the complexity for provision of the digital mixer is, however, very high. If, by way of example, the down-mixing process is carried out with oversampling by a factor of 4, then this doubles the complexity for provision of the mixer.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

The invention is directed to a device for down-mixing a radio-frequency signal, which has been received by radio, to baseband, the device having relatively little complexity and producing a baseband signal which is largely free of interference. The invention also includes a method which is used for the same purpose as the sought device and has the stated advantages.

The device according to the invention is used for down-mixing of a radio-frequency signal, which has been received by radio, to baseband. The device according to the invention is, in one example, integrated in the mobile radio which receives the radio-frequency signal.

In one embodiment of the invention the down-mixing of an intermediate frequency signal at a “low IF” frequency to baseband is carried out in two stages, using different sampling frequencies. For this purpose, the device according to the invention has a first, a second and a third mixer stage, as well as an analogue/digital converter stage.

The first mixer stage down-mixes the radio-frequency signal to a first analogue intermediate frequency signal by means of a first mixing frequency. The first analogue intermediate frequency signal is preferably at a “low IF” frequency. A first digital intermediate frequency signal is produced from the first analogue intermediate frequency signal by sampling by the analogue/digital converter stage. The second mixer stage down-mixes the first digital intermediate frequency signal to a second digital intermediate frequency signal by means of a second mixing frequency. The third mixer stage, finally, produces a digital baseband signal by down-mixing of the second digital intermediate frequency signal using a third mixing frequency. Furthermore, the second mixer stage samples the first digital intermediate frequency signal at a higher sampling frequency than that used by the third mixer stage to sample the second digital intermediate frequency signal.

The subdivision of the digital frequency conversion process into two stages can result overall in a very low-complexity implementation of the device according to the invention. This makes it possible to integrate the device according to the invention on the RF chip. The baseband chip receives a signal which has been sampled at the GSM symbol rate, or at twice the GSM symbol rate, via a digital standard interface. In consequence, the baseband chip need no longer support all feasible RF architectures, as in the past.

In comparison to a conventional “zero IF” procedure, the invention has the advantage that it reduces the requirements for 1/f noise, DC offset suppression and AM suppression.

In comparison to a conventional architecture, in which an intermediate frequency signal which has been converted to a “low IF” frequency is down-mixed to baseband with a high sampling rate, the invention reduces the complexity of the digital mixer by 50%.

The second mixer stage in one embodiment is preceded by a first decimation stage. The first decimation stage reduces the sample values of the first digital intermediate frequency signal. This is advantageous to the extent that, in consequence, the second mixer stage need not have as high a sampling frequency, and can thus be designed to be considerably simpler than a high frequency mixer.

In another embodiment a second decimation stage is connected upstream of the third mixer stage, in order to decimate the sample values of the second digital intermediate frequency signal. This measure means that the third mixer stage can be designed relatively cost-effectively, even for disadvantageous mixing frequencies, since its sampling rate is only low.

The first and second decimation stages may be, in one example, in the form of filters which have a lower order than the decimation filters which are required to provide a “low IF” architecture, as is shown in FIG. 2.

One embodiment of the invention provides for the mixing frequency which is required in the second mixer stage for down-mixing of the first digital intermediate frequency signal to be predetermined and to be fixed. This means that the mixing frequency for the third mixer stage must be set on the basis of the chosen “low IF” frequency. If the fixed mixing frequency for the second mixer stage is chosen skilfully, this mixer stage can be designed to be very simple.

According to one embodiment of the device according to the invention, the mixing frequency for the second mixer stage, by means of which the first digital intermediate frequency signal is down-mixed, essentially satisfies the following equation:

$${f}_{1} = \frac{{f}_{N / M}}{L} \qquad ( 1 )$$

In equation (1), f₁ is the mixing frequency for the second mixer stage, f_{N/M} is the sampling frequency at which the second mixer stage samples the first digital intermediate frequency signal, and L is an integer. In one particular example, the integer L is less than or equal to 12.

The condition described by equation (1) means that it is possible to produce the second mixer stage in such a way that a specific number of sine and cosine values are calculated in advance, with these values being stored in a memory, and in such a way that these values are used to mix the first digital intermediate frequency signal with the mixing frequency f₁.

A further embodiment of the invention is characterized in that the relationship between the frequency f_{lowIF} of the first digital intermediate frequency signal and the mixing frequency f₁ of the second mixer stage is as follows:
|f_{lowIF}−f₁≦f₀, f₀<<200 kHz (2)
This means that the second digital intermediate frequency signal is very close to the “zero IF” frequency. All that is then required in the third mixer stage is to correct the known frequency error of the second digital intermediate frequency signal. Furthermore, the low frequency of the second digital intermediate frequency signal is advantageous in the sense of a low-complexity implementation of the second decimation stage.

In one example, the first digital intermediate frequency signal is advantageously a “low IF” intermediate frequency signal. Its frequency should therefore not be greater than 110 kHz.

Yet another embodiment of the invention provides a particularly simple refinement of the second mixer stage. The second mixer stage can thus be provided by means of units which are designed to carry out additions and bit-shift operations.

Like the device according to the invention, the method according to the invention is used for down-mixing a radio-frequency signal, which has been received by radio, to baseband. The method comprises down-mixing the radio-frequency signal to a first analogue intermediate frequency signal, which is at a “low IF” frequency. The first analogue intermediate frequency signal is then sampled in order to produce a first digital intermediate frequency signal, and the first digital intermediate frequency signal is down-mixed to a second digital intermediate frequency signal. The second digital intermediate frequency signal is then down-mixed to a digital baseband signal, with the first digital down-mixing process being carried out at a higher sampling frequency than the second digital down-mixing process.

In comparison to conventional methods which are used for the same purpose, the method according to the invention has the same advantages as the device according to the invention.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention will be explained in more detail in the following text using examples and with reference to the drawings, in which:

FIG. 1 is a block diagram illustrating a circuit arrangement for baseband reception in the form of a “zero IF” architecture according to the prior art;

FIG. 2 is a block diagram illustrating a circuit arrangement for baseband reception in the form of a “low IF” architecture according to the prior art;

FIG. 3 is a block diagram illustrating a circuit arrangement for down-mixing of a radio-frequency signal, which has been received by radio, to baseband as one exemplary embodiment of the device according to the invention;

FIG. 4 is a schematic illustration of the positions of the wanted spectra and interference spectra before down-mixing with the frequency f₁; and

FIG. 5 is a schematic illustration of the positions of the wanted spectra and interference spectra after down-mixing with the frequency f₁.

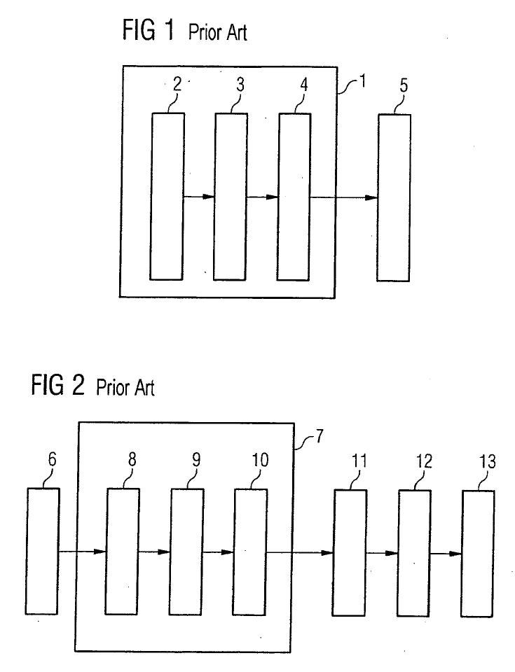

### DETAILED DESCRIPTION OF THE DRAWINGS

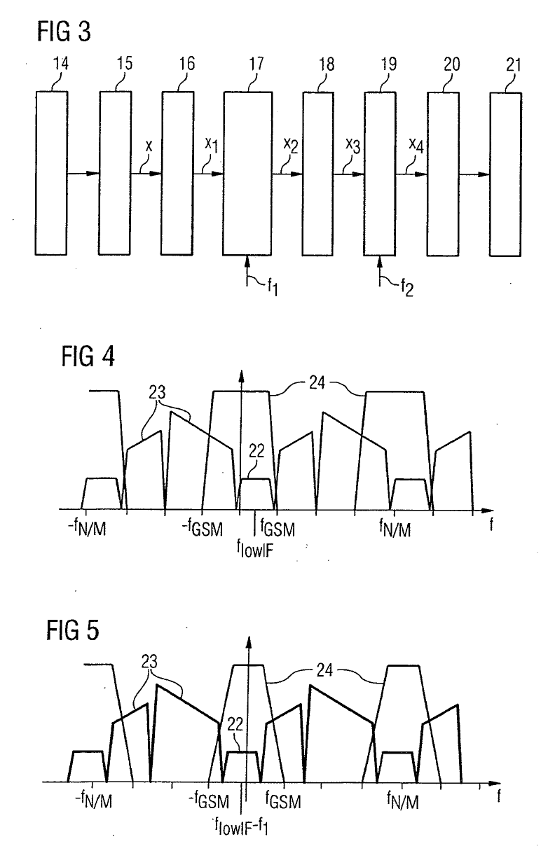

As one exemplary embodiment of the device according to the invention, FIG. 3 shows the block diagram of a circuit arrangement for down-mixing of a radio-frequency signal, which has been received by radio, to baseband. In this case, the radio transmission is based on the GSM Standard.

The circuit arrangement shown in FIG. 3 has a “low IF” architecture, that is to say a radio-frequency signal which has been received by radio is converted by an analogue mixer 14 to an analogue intermediate frequency signal at a “low IF” frequency f_{lowIF} The “low IF” frequency is, for example, variable.

The analogue intermediate frequency signal is then converted by means of an analogue/digital converter 15 to a digital intermediate frequency signal x. The analogue/digital converter 15 samples the analogue intermediate frequency signal for this purpose using a sampling frequency f_{N} which is greater by a factor N than the symbol rate f_{GSM} in the GSM Standard. In consequence:
f_{N}=N·f_{GSM} (3)
The intermediate frequency signal x, which has been oversampled by a factor of N, is decimated by a factor of M by means of a decimation stage 16. Accordingly, the decimation stage 16 emits at its output an intermediate frequency signal x₁ which is in a form that has been oversampled by a factor of N/M. One choice for the decimation factor M is, for example, 4.

Owing to the high oversampling factor of the intermediate frequency signal x which is fed to the decimation stage 16, the decimation stage 16 can be produced using low-order filters.

The decimation stage 16 is followed by a digital mixer 17. The digital mixer 17 samples the intermediate frequency signal x₁ at a sampling frequency f_{N/M}. The sampling frequency f_{N/M} is governed by the following definition equation:
f_{N/M}=N/M·f_{GSM} (4)
The digital mixer 17 mixes the intermediate frequency signal x₁ that is fed to its input with a fixed mixing frequency f₁ and thus produces an intermediate frequency signal x₂. The mixing frequency f₁ should be chosen so as to satisfy both of the following conditions:

$$\begin{matrix}{f}_{1} = \frac{{f}_{N / M}}{L} = \frac{N \cdot {f}_{GSM}}{M \cdot L} , \\ where L is an integer and L \leq 12 & ( 5 ) \\ \vert {f}_{lowIF} - {f}_{1} \vert \leq {f}_{0} , {f}_{0} << 200 kHz & ( 6 )\end{matrix}$$

The down-mixing of the intermediate frequency signal x₁ with the mixing frequency f₁ to the intermediate frequency signal x₂ can be described by rotation through an angle Φ₁=2π*f₁/f_{N/M}:
x₂[k]=x₁[k]·e^{jkΦ}_{₁}, k=0, 1, 2, . . . , K−1 (7)
In the equation (7), K indicates the number of data symbols in one GSM-TDMA time slot.

In general, k different sine and cosine values as well as multiplications of these values by the input signal are required in order to produce the relationship described by equation (7). However, the number of sine and cosine values is reduced to less than 2L different values by the condition in the equation (5). By way of example, only the following values are required for L=10:
sin(kΦ₁)ε{−0.9511; −0.5878; 0; 0.5878; 0.9511} (8)
cos(kΦ₁)ε{−1; −0.8090; −0.3090; 0.3090; 0.8090; 1} (9)
These values can be approximated with sufficient accuracy by numbers in which the multiplications can be replaced by additions and bit-shift operations. The digital mixer 17 can thus be produced in the form of a very simple mixer with one fixed mixing frequency f₁.

The condition stated in equation (6) ensures that the intermediate frequency signal x₂, which has been down-mixed by means of the mixing frequency f₁, is very close to 0 Hz. This results in a less stringent requirement for the frequency response of the decimation stage 18 which follows the digital mixer 17. The decimation stage 18 decimates the intermediate frequency signal x₂ and thus produces an intermediate frequency signal x₃, which has an oversampling factor of 2.

The intermediate frequency signal x₃ is passed to a digital mixer 19, which down-mixes the intermediate frequency signal x₃ by means of a mixing frequency f₂ to baseband. In consequence, the mixing frequency f₂ is governed by the following definition equation:
f₂=f_{lowIF}−f₁ (10)
A baseband signal X₄ is emitted at the output of the digital mixer 19:

$$\begin{matrix}{x}_{4} [ k ] = {x}_{3} [ k ] \cdot {ⅇ}^{j k {Φ}_{2}} , k = 0 , 1 , 2 , … , K - 1 & ( 11 ) \\ {Φ}_{2} = \frac{2 π \cdot ( {f}_{lowIF} - {f}_{1} )}{2 \cdot {f}_{GSM}} & ( 12 )\end{matrix}$$

In order to mix the intermediate frequency signal x₃ to the correct frequency, a method is used which is described in the German Laid-Open Specification DE 199 48 899 A1 and International Publication WO 0128176, and which have been proposed there for correction of frequency errors. The cited Laid-Open Specification and PCT publication are hereby incorporated by reference in the disclosure content of the present patent application in their entirety. The cited method is an iterative algorithm. Each rotation through the angle Φ is approximated by R microrotations with a predefined angle αₖ:
αₖ=arctan(2^{-k}), k=0, 1, 2, . . . , R−1 (13)
Φ≈σ₀·α₀+σ₁·α₁+ . . . +σ_{R-1}·α_{R-1}, σₖ=±1 (14)
The mathematical sign σₖ controls the direction of the k-th microrotation and is governed by the angle Φ and the rotated angle from the k−1 preceding microrotations. Each microrotation can be produced by single shift-add operations, with x_{I} denoting the I component, and x_{Q} denoting the Q component:
x_{I}^{k}=x_{I}^{k-1}−σₖ·2^{-k}·x_{Q}^{k-1} (15)
x_{Q}^{k}=σₖ·2^{-k}·x_{I}^{k-1}+x_{Q}^{k-1} (16)
The accuracy of the angular approximation is governed by the number of iterations.

The baseband signal x₄ produced in this way is passed to a channel filter 20, which follows the digital mixer 19. A digital signal processor 21 then carries out the rest of the processing.

For clarity reasons, FIG. 3 does not illustrate the splitting of the complex signals into the quadrature components I and Q. Such splitting into two signal paths may, however, be provided.

The following text shows examples of values for the mixing and sampling frequencies:
“low IF”-frequency f_{lowIF}=100 kHz
sampling frequency of the digital mixer 17: 4*f_{GSM}
sampling frequency of the digital mixer 19: 2*f_{GSM}
mixing frequency f₁=4*f_{GSM}/10
mixing frequency f₂=−8.333 kHz

The values mentioned above can be used as the basis for the process of down-mixing, which is to be carried out by the digital mixer 17, of the intermediate signal x₁ on the basis of the values cos(0), cos(π/5), cos(2π/5), sin(π/5) and sin(2π/5).

FIGS. 4 and 5 show, schematically, the positions of the wanted spectra and interference spectra before and after the down-mixing with the fixed mixing frequency f₁. The spectrum of the wanted signal is in each case provided with the reference symbol 22, while the spectra of the interference signals have the reference symbol 23. The frequency response of the decimation filter is indicated by the reference symbol 24.

FIG. 4 shows the spectra of the intermediate frequency signals which have been converted to the intermediate frequency f_{lowIF}, after M-times decimation. If the aim were to decimate the intermediate frequency signal without any aliasing effects to a sampling frequency of 2f_{GSM}, a filter with a very steep transitional area would be required for this purpose. For this reason, the intermediate frequency signal as shown in FIG. 4 is first of all, according to the invention, down-mixed with the mixing frequency f₁, and is then close to the “zero IF” frequency, as is illustrated in FIG. 5. The small frequency offset f₂ from 0 Hz can be corrected for a low sampling frequency. This measure reduces the stringency of the requirement for the frequency response of the downstream filter. In consequence, a low-order filter can be used in the decimation stage 18 in order to decimate the intermediate frequency signal x₂ to a sampling frequency of 2f_{GSM} without any aliasing effects.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

1. A device for down-mixing a radio-frequency signal, which has been received by radio, to baseband, comprising:
a first mixer stage configured to produce a first analogue intermediate frequency signal at a “low IF” frequency by down-mixing the radio-frequency signal;
an analogue/digital converter stage configured to produce a first digital intermediate frequency signal by sampling of the first analogue intermediate frequency signal;
a second mixer stage configured to produce a second digital intermediate frequency signal by down-mixing the first digital intermediate frequency signal; and
a third mixer stage configured to produce a digital baseband signal by down-mixing the second digital intermediate frequency signal, wherein the second mixer stage comprises a higher sampling frequency than the third mixer stage.

2. The device of claim 1, further comprising a first decimation stage coupled upstream of the second mixer stage and downstream of the analogue/digital converter stage, and configured to reduce a number of sample values of the first digital intermediate frequency signal.

3. The device of claim 1, further comprising a second decimation stage coupled upstream of the third mixer stage and downstream of the second mixer stage, and configured to reduce a number of sample values of the second digital intermediate frequency signal.

4. The device of claim 1, wherein a mixing frequency of the second mixer stage for down-mixing the first digital intermediate frequency signal is fixed.

5. The device of claim 1, wherein a mixing frequency of the second mixer stage for down-mixing the first digital intermediate frequency signal is equal to the quotient of a sampling frequency of the second mixer stage and an integer that is less than or equal to 12.

6. The device of claim 1, wherein a difference between a frequency of the first digital intermediate frequency signal and a mixing frequency of the second mixer stage for down-mixing the first digital intermediate frequency signal is less than 200 kHz.

7. The device of claim 1, wherein a frequency of the first digital intermediate frequency signal is variable and less than 110 kHz.

8. The device of claim 1, wherein the second mixer stage is configured to down-mix the first digital intermediate frequency signal using addition and bit-shift operation components.

9. A method for down-mixing a radio-frequency signal, which has been received by radio, to baseband, comprising:
(a) down-mixing the radio-frequency signal is down-mixed to a first analogue intermediate frequency signal at a “low IF” frequency;
(b) sampling the first analogue intermediate frequency signal to produce a first digital intermediate frequency signal;
(c) down-mixing the first digital intermediate frequency signal to a second digital intermediate frequency signal; and
(d) down-mixing second digital intermediate frequency signal to a digital baseband signal, wherein the down-mixing in act (c) is carried out at a higher sampling frequency than the down-mixing in act (d).

10. The method of claim 9, further comprising decimating the sample values of the first digital intermediate frequency signal prior to down-mixing in act (c).

11. The method of claim 9, further comprising decimating sample values of the second digital intermediate frequency signal prior to the down-mixing in act (d).

12. The method of claim 9, wherein a mixing frequency for down-mixing the first digital intermediate frequency signal to the second digital intermediate frequency signal is fixed.

13. The method of claim 9, wherein a mixing frequency for down-mixing the first digital intermediate frequency signal to the second digital intermediate frequency signal is an integer less than or equal to 12, and is equal to the quotient of a sampling frequency in act (c).

14. The method of claim 9, wherein a difference between a frequency of the first digital intermediate frequency signal and a mixing frequency for down-mixing of the first digital intermediate frequency signal to the second digital intermediate frequency signal is less than 200 kHz.

15. The method of claim 9, wherein a frequency of the first digital intermediate frequency signal is variable and less than 110 kHz.

16. The method of claim 9, wherein the down-mixing in act (c) is performed using addition operations and bit-shift operations.
